(19) United States
(12) Patent Application Publication
(10) Pub. No.: US 2011/0069939 A1
(43) Pub. Date: Mar. 24, 2011

(54) APPARATUS AND METHOD FOR SCENE SEGMENTATION

(75) Inventors: Yoon-Hee CHOI, Suwon-si (KR); Sang-Wook Kang, Anyang-si (KR); Il-Hwan Choi, Yongin-si (KR)

(73) Assignee: SAMSUNG ELECTRONICS CO., LTD., Suwon-si (KR)

(21) Appl. No.: 12/887,338

(22) Filed: Sep. 21, 2010

(30) Foreign Application Priority Data
Sep. 23, 2009 (KR) 10-2009-0090183

(51) Int. Cl. H04N 5/93

(52) U.S. Cl. 386/278; 386/E05.028

(57) ABSTRACT

An apparatus and method of segmenting video content received in real-time is provided. Video content may be received through broadcasting or communications, and the video content may be segmented into scenes which are a series of semantic segments. A normalized-cut algorithm may be used for scene segmentation of video content. The normalized-cut algorithm may be applied for detecting locations at which a scene segmentation cost is minimized, and to decide a scene segmentation location based on the appearance frequency of the locations. If captions related to video content are received, a text segmentation algorithm may be applied to the captions to estimate text segmentation costs and scene segmentation may be performed using a merged segmentation cost obtained by linear merging scene segmentation costs and text segmentation costs.

### CROSS-REFERENCE TO RELATED APPLICATION(S)

This application claims the benefit under 35 U.S.C. §119(a) of Korean Patent Application No. 10-2009-0090183, filed on Sep. 23, 2009, the entire disclosure of which is hereby incorporated by reference for all purposes.

### BACKGROUND

1. Field

The following description relates to an apparatus and method for scene segmentation, and more specifically, an apparatus and method to retrieve, browse, or summarize multimedia content.

2. Description of the Related Art

With the advance of multimedia technologies, nonlinear video retrieving and browsing has been developed to provide selective browsing, reproduction of a desired portion of video to quickly summarize information regarding the video, or quickly shifting to a desired part of video content. Nonlinear video searching and browsing typically involves shot segmentation and shot clustering.

In video sequences, a series of video frames are gathered to form a shot, which is a continuous recording unit. In other words, a shot is a sequence of continuous video frames acquired from a camera. For shot segmentation, various shot detection algorithms have been utilized, for example, a scheme of using a color histogram between two adjacent frames or between two frames spaced a certain time interval apart. Shot clustering is a process of detecting scenes which have a logical thematic topic from detected shots. Shot clustering may be applied to video content for segmentation into a plurality of scenes, wherein each scene is composed of a series of sub-scenes or a series of shots. Accordingly, structure information of video content is extracted through shot clustering. The extracted structure information of video content is used for video indexing according to key frames, video content summarization, and on the like.

### SUMMARY

The following description relates to a scene segmentation apparatus and method applicable for video content.

In one general aspect, there is provided a scene segmentation apparatus including a scene segmentation cost estimator and a scene segmentation detector. The scene segmentation cost estimator receives shots and estimates scene segmentation costs using an estimation value such that a similarity between shots included in each of two groups of shots is maximized and a similarity between the two groups of shots is minimized. The scene segmentation detector detects a scene segmentation location between the shots, with reference to the scene segmentation costs; the scene segmentation location is a location at which the scene segmentation cost is minimized.

The scene segmentation apparatus may include a memory to store the results of calculations for detecting the scene segmentation location for the received shots, wherein the scene segmentation cost estimator recursively estimates, when a new shot is received, scene segmentation costs for shots including the newly received shot and any of previously received shots, using the stored results of the calculations.

When detecting the scene segmentation location, the scene segmentation cost estimator may distributively estimate scene segmentation costs for shots remaining after the scene segmentation location, while continuing to receive new shots.

When a first location at which the scene segmentation cost is minimized is repetitively detected at least a predetermined number of times, the scene segmentation detector may determine the first location as the scene segmentation location.

The scene segmentation detector may determine the scene segmentation location according to a location with highest frequency of minimizing scene segmentation costs within a window that is determined as a predetermined number of shots or as a predetermined time period.

The scene segmentation apparatus may include a text segmentation processor to estimate a text segmentation cost for text received over time; a merged segmentation cost estimator to estimate a scene-text merged segmentation cost by linear merging of the estimated text segmentation Cost and the estimated scene segmentation cost; and a merged scene segmentation detector to detect a scene segmentation location at which the merged segmentation cost is minimized.

The text segmentation processor may segment text into text segments by applying time intervals between words to a statistical model for text segmentation.

The scene segmentation detector may determine a second location as the scene segmentation location when the second location at which the merged segmentation cost is minimized is repeatedly detected at least a predetermined number of times.

The scene segmentation detector may determine the scene segmentation location according to a location with highest frequency of minimizing merged segmentation costs within a window that is determined as a predetermined number of shots or as a predetermined time period.

In another general aspect, there is provided a scene segmentation method including: estimating, when a new shot is received, scene segmentation costs using an estimation value such that a similarity between shots included in each of two groups of shots is maximized and a similarity between the two groups of shots is minimized; and detecting a scene segmentation location between the shots, with reference to the scene segmentation costs, wherein the scene segmentation location is a location at which the scene segmentation cost is minimized.

The scene segmentation method may include storing the result of detecting the scene segmentation location for the received shots; and recursively estimating, when a new shot is received, scene segmentation costs for shots including the newly received shot and any of previously received shots, using the stored results of the calculations.

The scene segmentation method of claim may include distributively estimating scene segmentation costs for shots remaining after the scene segmentation location, while continuing to receive new shots.

The scene segmentation method may include estimating a text segmentation cost for text received over time; estimating a scene-text merged segmentation cost by linear merging of the estimated text segmentation cost and the estimated scene segmentation cost; and detecting a scene segmentation location at which the scene-text merged segmentation cost is minimized.

The calculating of the text segmentation cost may be performed using a text segmentation model in which time intervals between words are applied to a statistical model for text segmentation.

The detecting of the scene segmentation location may include determining a first location as the scene segmentation location when the first location at which the merged scene segmentation cost is minimized is repetitively detected at least a predetermined number of times.

The detecting of the scene segmentation location may include determining the scene segmentation location according to a location with highest frequency of minimizing merged scene segmentation costs within a window that is determined as a predetermined number of shots or as a predetermined time period.

In another general aspect, there is provided a scene segmentation apparatus including: a text segmentation processor to estimate a text segmentation for text received over time; and a scene segmentation detector to detect a scene segmentation location of video data received over time according to the text segmentation cost.

The text segmentation processor may segment text into text segments by applying detected time intervals between words to a statistical model for text segmentation.

The scene segmentation detector may determine the scene segmentation location according to a text segmentation location at which the text segmentation cost is repetitively detected at least predetermined number of times for the received shots.

The scene segmentation detector may determine the scene segmentation location according to a location with highest frequency of minimizing text segmentation costs within a window that is determined as a predetermined number of shots or as a predetermined time period.

Other features and aspects may be apparent from the following detailed description, the drawings, and the claims.

### BRIEF DESCRIPTION OF THE DRAWINGS

FIG. 1 is a diagram illustrating an example of a configuration of a video sequence.

FIG. 2 is a diagram illustrating a minimum-cut.

FIG. 3 is a diagram illustrating an example of a scene segmentation apparatus.

FIG. 4 is a diagram illustrating parameters used for scene segmentation.

FIG. 5 is a diagram illustrating an example of a method of determining locations for scene segmentations.

FIG. 6 is a diagram illustrating another example of a method of determining locations for scene segmentations.

FIG. 7 is a diagram illustrating an example of a scene segmentation apparatus.

FIG. 8 is a diagram illustrating an example of a final cost obtained by linear merging of scene segmentation costs and text segmentation costs.

FIG. 9 is a flowchart illustrating examples of operations in which the scene segmentation apparatus of FIG. 7 applies scene segmentation to video content received in substantially real-time.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing steps and/or operations described is an example; however, the sequence of steps and/or operations is not limited to that set forth herein and may be changed as is known in the art, with the exception of steps and/or operations necessarily occurring in a certain order. Also, descriptions of well-known functions and constructions may be omitted for increased clarity and conciseness.

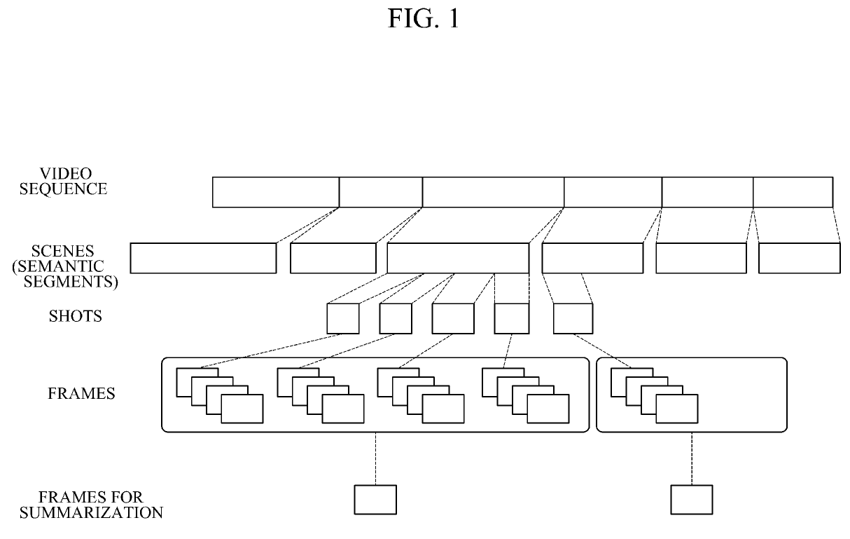

FIG. 1 is a diagram illustrating an example of a configuration of a video sequence.

A video sequence is typically composed of a plurality of scenes, each of the plurality of scenes having a logical thematic topic segment. A logical thematic topic segment is typically a segment semantically classified by content, an event, a place, and the like, associated with a specific sub-theme in video content.

A scene includes one or more shots, which are a series of video frames acquired by a camera. Video summarization information may be provided to apply scene segmentation to video content by extracting a representative frame from among frames forming each scene. Accordingly, representative frames of individual scenes may be determined as summarization frames for each logical story unit.

When the video content is a broadcasting program and a user beings watching the broadcasting program partway through its duration, the user may view the video summarization information to roughly determine the previously broadcasted content of the program, and/or to check the content of broadcasting programs being received on channels other than the program which he or she is watching. Further, since the method of providing summarization information of video content does not require a large capacity of a frame buffer, it may be efficiently applied to embedded systems.

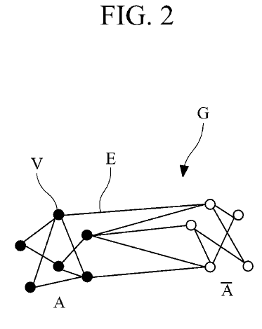

FIG. 2 is a diagram illustrating a minimum-cut.

Scene clustering or segmentation has generally been based on graph theory. According to graph theory, it may be presumed a graph G is produced using a group V of nodes and a group E of edges representing connection relationships between the nodes, and then the graph G may be defined as G=(V, E), wherein the nodes (V) represent representative images of video shots or key frames sampled from video, and the edges (E) represent lines each connecting two arbitrary nodes i and j in the graph G. A similarity between the nodes i and j can be expressed as a weight w_{i,j}.

A minimum-cut is used to partition a graph G into two groups. That is, the minimum-cut partitions a group in such a manner that a cut value is minimized, which can be written as Equation 1 below. In FIG. 2 and Equation 1, Ā and A represent two groups into which nodes are grouped.

$$Cut ( A , \overline{A} ) = {\sum }_{j ∈ A , i ∈ \overline{A}} {w}_{j , i} , \qquad ( 1 )$$

where V=A∪Ā, A∩Ā=φ. However, the minimum-cut may result in one of two partitioned groups including only a few isolated nodes. In order to solve the minimum-cut problem, a standard referred to as a “normalized-cut” has been proposed. A normalized-cut NCut(A,Ā) can be written as Equation 2 below.

$$NCut ( A , \overline{A} ) = \frac{Cut ( A , \overline{A} )}{assoc ( A , V )} + \frac{Cut ( A , \overline{A} )}{assoc ( \overline{A} , V )} , \qquad ( 2 )$$

where assoc(A,V)=Σ_{uεA.vεV}^{W}_{u,v} represents a similarity (that is, a sum of weights) of nodes included in group A with respect to all other nodes in the corresponding graph, and assoc(Ā, V) represents a similarity of nodes included in group Ā with respect to all other nodes in the graph. Hereinafter, a method for segmenting scenes using the normalized-cut when video content is received over time (such as a real-time broadcasting program), as well as when video content is stored in advance, will be described.

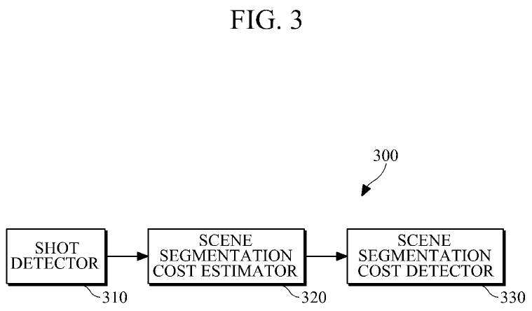

FIG. 3 is a diagram illustrating an example of a scene segmentation apparatus 300.

The scene segmentation apparatus 300 includes a shot detector 310, a scene segmentation cost estimator 320, and a scene segmentation detector 330.

The shot detector 310 detects shots according to similarities of color histograms, which reflect color characteristics of video. The shot detector 310 also transfers the detected shots to the scene segmentation cost estimator 320. Shots may be extracted according to various shot detection methods.

The scene segmentation cost estimator 320 estimates scene segmentation costs of video content by applying a normalized-cut, maximizing a similarity between shots included in each group while minimizing a similarity between groups, when received shots are divided into two groups. Whenever a shot is newly received, the scene segmentation cost estimator 320 estimates scene segmentation costs if shots received over time can be grouped into two groups.

A similarity between shots may be measured according to various methods that utilize key frames selected from the shots. For example, when a single key frame is selected from each shot, a similarity between shots may be determined using a similarity between key frames. However, when several key frames are extracted from a shot, a similarity between shots may be determined to be (i) the highest similarity among similarities between all possible key frames, or (ii) a mean value of similarities between all possible key frames. Furthermore, additional methods of defining a similarity between shots may be applied.

The scene segmentation apparatus 300 may further include a memory (not shown) to store the results of prior calculations for minimizing scene segmentation costs between previously received shots. The memory may be connected to the scene segmentation cost estimator 320, and the memory may be positioned inside or outside the scene segmentation apparatus 300. That is, the memory may be an internal memory or an external memory with respect to the scene segmentation apparatus 300.

The scene segmentation cost estimator 320 estimates, whenever a new shot is detected, scene segmentation costs for all received shots. The scene segmentation cost estimator 320 may estimate scene segmentation costs according to a recursive method, in order to reduce the amount of calculations. Further, when receiving a new shot, the scene segmentation cost estimator 320 may recursively estimate scene segmentation costs using previously estimated scene segmentation costs if shots including the new shot and the previously received shots are grouped into two groups.

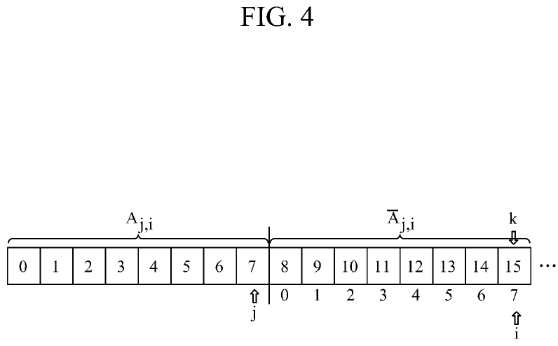

As another example, when the scene segmentation detector 330 detects a scene segmentation location, the scene segmentation cost estimator 320 may distributively estimate scene segmentation costs while continuing to receive new shots. That is, upon detecting a scene segmentation location, the scene segmentation estimator 320 may estimate scene segmentation costs for only the shots that remain after the scene segmentation location, instead of estimating scene segmentation costs for all received shots. The recursive method for estimating scene segmentation costs and the method for estimating scene segmentation costs after detection of scene segmentation are described with reference to FIG. 4.

The scene segmentation detector 330 may determine a location at which a scene segmentation is to be made by detecting a shot boundary at which a scene segmentation cost is minimized with reference to the scene segmentation costs. The scene segmentation detector 330 may determine a location with a minimum scene segmentation cost; the location may be detected a certain number of times or more frequently as compared to a scene segmentation location. Alternatively, the scene segmentation detector 330 may determine, as a scene segmentation location, a location with the highest frequency of minimized scene segmentation costs, within a window that may be set as a certain number of shots or as a certain time period.

FIG. 4 is a diagram illustrating parameters used for scene segmentation.

Real-time video has a characteristic in that the number of nodes increases over time. To reflect the characteristic in a scene segment, variables i, j, and k may be provided. Accordingly, a normalized-cut NCutₖ (Aⱼ, Āᵢ) may be modified to Equation 3 below, wherein A represents a group having i+1 shots, Ā represents a group having j+1 shots, k represents indexes for received shots, j represents indexes of the shots included in the A group, and i represents indexes of the shots included in the Ā group.

$${NCut}_{k} ( {A}_{j} , {\overline{A}}_{i} ) = \frac{{Cut}_{k} ( {A}_{j} , {\overline{A}}_{i} )}{{Assoc}_{k} ( {A}_{j} ) + {Cut}_{k} ( {A}_{j} , {\overline{A}}_{i} )} + \frac{{Cut}_{k} ( {A}_{j} , {\overline{A}}_{i} )}{{Assoc}_{k} ( {\overline{A}}_{j , i} ) + {Cut}_{k} ( {A}_{j} , {\overline{A}}_{i} )} \qquad ( 3 )$$

Here Cutₖ(Aⱼ, Āᵢ)=Σ_{uεA}_{ⱼ}_{,vεĀ}_{ᵢ}w_{u,v} Assocₖ(Aⱼ)=Σ_{u,vεA}_{ⱼ} w_{u,v} and Assocₖ(Ā_{i,j})=Σ_{u,vεĀ}_{ᵢ} w_{u,v} where, w_{u,v} represents a similarity between shots u and v.

When a new shot is detected and received upon real-time scene segmentation, NCutₖ (Aⱼ,Āᵢ) is again calculated at all j locations with respect to increased k. Accordingly, Assocₖ(Aⱼ), Assocₖ(Ā_{j,i}), and Cutₖ(Aⱼ,Āᵢ) are each calculated and these repetitive calculations may impose a significant processing load for real-time operation even though Assocₖ(Aⱼ), Assocₖ(A_{j,i}), and Cutₖ(Aⱼ,Āᵢ) can be directly calculated using their definitions.

According to an example, NCutₖ(A_{j,Ā}ᵢ) is effectively calculated by recursively determining Assocₖ(Aⱼ) and Assocₖ(Ā_{j,i}) with respect to Assocₖ₋₁(Aⱼ) and Assocₖ₋₁(Ā_{j,i}).

Assocₖ(Aⱼ) may be recursively determined according to Equation 4 below.

$${Assoc}_{k} ( {A}_{j} ) = \{ \begin{matrix}{w}_{0 , 0} , & if k = 0 \\ {Assoc}_{j} ( {A}_{j} ) , & if k \neq 0 and 0 \leq j \leq k - 1 \\ {Assoc}_{k - 1} ( {A}_{j - 1} ) + {w}_{k , k} + 2 \cdot {\sum }_{j = 0}^{k - 1} {w}_{j , i} , & if j = k \neq 0\end{matrix} \qquad ( 4 )$$

Meanwhile, Assocₖ(Ā_{j,i}),k≧1 also may be recursively determined according to Equation 5 below.

$${Assoc}_{k} ( {\overline{A}}_{k - j - 1 , j} ) = \{ \begin{matrix}{c}_{0 , k} , & if j = 0 \\ {Assoc}_{k - 1} ( {\overline{A}}_{k - j - 1 , j - 1} ) + {c}_{j , k} , & otherwise ,\end{matrix} \qquad ( 5 )$$

where 0≦j≦k−1 and

$$\{ \begin{matrix}{c}_{0 , k} = {w}_{k , k} \\ {c}_{j , k} = {c}_{j - 1 , k} + 2 {w}_{k - j , k} .\end{matrix}$$

Finally, Cutₖ(Aⱼ,Bᵢ),k≧1 may be obtained by Equation 6 using the results of the above calculations.

$${Cut}_{k} ( {A}_{j} , {\overline{A}}_{k - j - 1} ) = \frac{1}{2} ( {Assoc}_{k} ( {A}_{k} ) - {Assoc}_{k} ( {\overline{A}}_{j , k - j - 1} ) - {Assoc}_{j} ( {A}_{j} ) ) , \qquad ( 6 )$$

where 0≦j≦k−1.

By using the recursive routine described above, calculation time may be reduced, although additional memory is used to store the previously obtained values. Assocₖ(Aⱼ), Assocₖ(Ā_{j,i}) and Cutₖ(Aⱼ,Āᵢ) may be stored in the form of a 2-dimensional table in a memory.

Meanwhile, when a scene segmentation is implemented, a table for Assocₖ,(Aⱼ), Assocₖ,(Ā_{j,i}) and Cut_{k′}(Aⱼ,Āᵢ) and may be newly created from a start point of a new scene segment, wherein k′ identifies shots remaining after the scene segmentation. The table for Assocₖ,(Aⱼ), Assocₖ,(A_{i,j}) and Cut_{k′}(Aⱼ,Āᵢ) may be processed relatively quickly as compared to the previously created table for Ascocₖ(Aⱼ), Assocₗ(Ā_{j,i}) and Cutₖ(Aⱼ,Āᵢ). The processing may be implemented by an in-place memory copy method, which is a method of copying data from one location to another location within a buffer memory.

Assoc_{k′}(A_{k′}) may be updated using Assocₖ(Ā_{j,i}), which may be determined according to Equation 7.

Assoc_{k′}(A_{k′})=Assoc_{k′+j}_{_{seg}}(Āⱼ_{_{seg−1}}_{,k′}), (7)

where 0≦k′≦k−j_{seg}.

Since a table updated by Equation 7 includes a value of Assoc_{k′}(A_{k′}), a general location Assoc_{k′}(Aⱼ) may be obtained from Assoc_{k′}(A_{k′}), through a table lookup as shown in Equation 8 below.

Assoc_{k′}(Aᵢ)=Assocⱼ(Aⱼ), if k≠0 and 0≦j≦k′−1 (8)

Assoc_{k′}(Ā_{j,i}) may be updated using Assocₖ(Ā_{j,i}), as shown in Equation 9 below.

Assoc_{k′+i}(Ā_{k′-1,i})=Assoc_{k′+j}_{_{seg}}₊ᵢ(Ā_{k′+j}_{_{seg−1}}_{,i}) (9)

where 1≦k′≦k−j_{seg}, 0≦i≦k−k′−j_{seg}.

Finally, Cutₖ′(Aⱼ,Āᵢ) may be obtained from the results of Equations 7 and 9, as shown in Equation 10 below.

$${Cut}_{{k}^{′}} ( {A}_{i} , {\overline{A}}_{{k}^{′} - i - 1} ) = \frac{1}{2} ( {Assoc}_{{k}^{′}} ( {A}_{{k}^{′}} ) - {Assoc}_{{k}^{′}} ( {\overline{A}}_{i , {k}^{′} - i - 1} ) - {Assoc}_{i} ( {A}_{i} ) ) , \qquad ( 10 )$$

where 1≦k′≦k−j_{seg}, 0≦i≦k′−1.

A normalized-cut NCut_{k′}(Aⱼ,Āᵢ) may be calculated from the updated table, as shown in Equation 11 below.

$${NCut}_{{k}^{′}} ( {A}_{j} , {\overline{A}}_{i} ) = \frac{{Cut}_{{k}^{′}} ( {A}_{j} , {\overline{A}}_{i} )}{{Assoc}_{{k}^{′}} ( {A}_{j} ) + {Cut}_{{k}^{′}} ( {A}_{j} , {\overline{A}}_{i} )} + \frac{{Cut}_{{k}^{′}} ( {A}_{j} , {\overline{A}}_{i} )}{{Assoc}_{{k}^{′}} ( {\overline{A}}_{j , i} ) + {Cut}_{{k}^{′}} ( {A}_{j} , {\overline{A}}_{i} )} , \qquad ( 11 )$$

where 1≦k′≦k−j_{seg}.

Accordingly, since normalized-cuts for k−j_{seg} shots are processed as a scene segmentation is performed, calculations may be concentrated. This problem may be overcome by distributing calculations for normalized-cuts by a factor M whenever a new shot is detected.

For example, if a new shot is received when M is set as 2, normalized-cuts for shots when k′ is 0 and 1 may be calculated, and when a next shot is received, normalized-cuts for shots when k′ is 2 and 3 may be calculated.

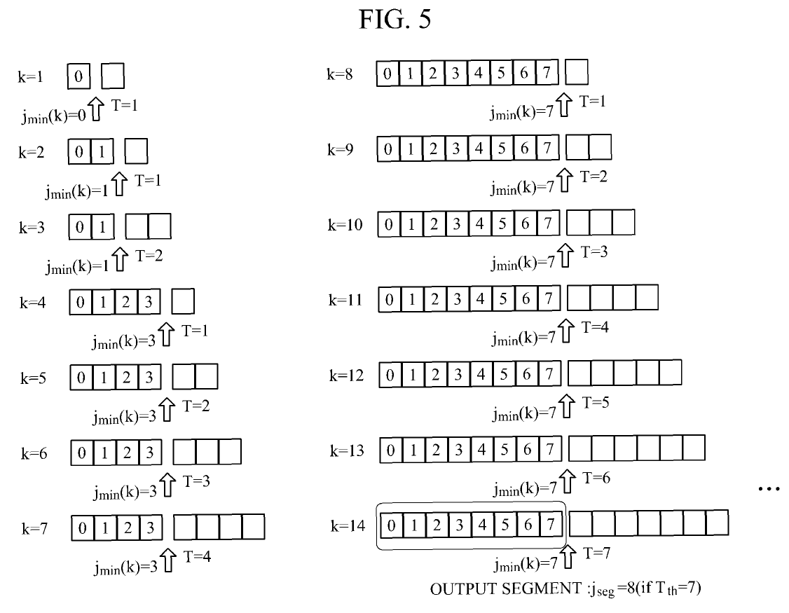

FIG. 5 is a diagram illustrating an example of a method of determining locations for scene segmentations.

If a value of a location jₘᵢₙ(k) at which a scene segmentation cost is minimized does not change as k increases, a scene segmentation at the location of jₘᵢₙ(k) may be considered to be stable. Accordingly, when Equation 12 is satisfied, a scene segmentation location is determined.

j_{seg}=jₘᵢₙ(k)+1, if jₘᵢₙ(k)=jₘᵢₙ(k−1)=. . . =jₘᵢₙ(k−Tₜₕ−1), (12)

where Tₜₕ is a parameter for determining stability of a scene segmentation.

Referring to FIG. 5, if Tₜₕ is 7, a location at which jₘᵢₙ(k)=7 is detected 7 times from when k=8 to when k=14. Accordingly, j_{seg} may be determined as 8.

In the above example, a location at which a scene segmentation cost for video content is minimized is represented as jₘᵢₙ(k). However, when captions for video content are received along with the video content, jₘᵢₙ(k) may represent a location at which a linear sum of a scene segmentation cost for the video content and a text segmentation cost for the captions is minimized.

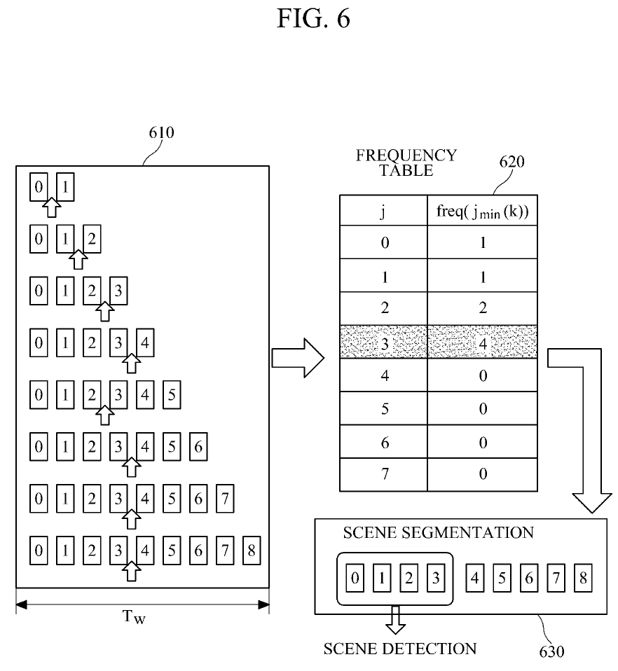

FIG. 6 is a diagram illustrating another example of a method of determining locations for scene segmentations.

Another method for determining scene segmentation locations is to use the frequency of a scene segmentation cost being minimized in a given window T_{w}. The frequency of a location jₘᵢₙ(k) at which a scene segmentation cost is minimized in a given window T_{w} is represented as a frequency table 620. The scene segmentation detection unit 330 may determine a location having the highest frequency as a scene segmentation location.

In the example illustrated in FIG. 6, it may be presumed that if a window size is 9, the frequency freq(jₘᵢₙ(k)) of jₘᵢₙ is highest when j is 3. Accordingly, as illustrated by a reference number 630, a segment from a shot 0 to a shot 3 may be determined and detected as a scene. The scene segmentation apparatus 300 updates shots such that the shots 4 to 8 remain, and therefore may perform a scene segmentation on the remaining shots 4 to 8 and newly received shots.

As an example, a window may be defined as a certain number of shots, as a certain number of key frames, or as a certain time period. Furthermore, the window may be defined according to other examples that define the window as a range within which the frequency of a location at which a scene segmentation cost is minimized is counted.

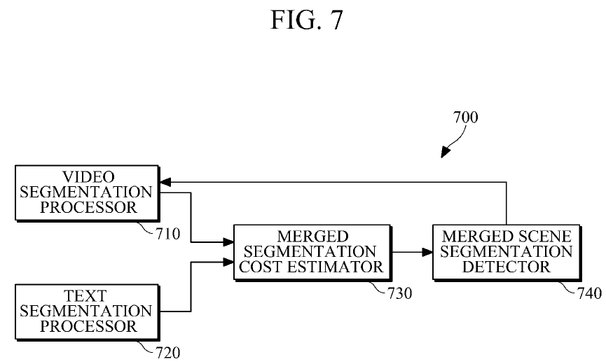

FIG. 7 is a diagram illustrating an example of a scene segmentation apparatus 700.

Referring to FIG. 7, the scene segmentation apparatus 700 includes a video segmentation processor 710, a text segmentation processor 720, a merged segmentation cost estimator 730 and a merged scene segmentation detector 740.

Similar to the scene segmentation apparatus illustrated in FIG. 3, the video segmentation processor 710 may segment the received shots into two groups whenever shots are detected and received. The video segmentation processor 710 may also detect a location at which a similarity between shots included in each group is maximized and a similarity between groups is minimized. The video segmentation processor 710 operates similar to the scene segmentation apparatus 300 and thus a description there for will be omitted.

The text segmentation processor 720 may estimate a text segmentation cost for text received over time. The text segmentation processor 720 may use a text segmentation model, in which time intervals between words are applied to a statistical model for text segmentation, to estimate a text segmentation cost for received text. A method of estimating a text segmentation cost is described further below.

The merged segmentation cost estimator 730 may estimate a scene-text merged segmentation cost by applying linear merging of an estimated text segmentation cost and an estimated scene segmentation cost.

The merged scene segmentation detector 740 may determine a location at which a merged segmentation cost is minimized as a scene segmentation location. The merged scene segmentation detector 740 may determine, as a scene segmentation location, a location with a minimum merged scene segmentation cost that is repetitively detected at least a certain number of times. Alternatively, the merged scene segmentation detector 740 may determine, as a scene segmentation location, a location with the highest frequency of a scene segmentation cost being minimized within a window that is set as a certain number of shots or as a certain time period.

Hereinafter, operation for text segmentation will be described.

The text segmentation processor 720 may determine a location at which the probability of scene segmentation for given text is maximized, using a text segmentation model in which a time concept is applied to a statistical model, such as that taught in a paper entitled “A Statistical Model for Domain-Independent Text Segmentation”, by Masao Utiyama and Hitoshi Isahara.

A document W=w₁, w₂, . . . wₙ may include n words and a time interval D=d₁ . . . dₙ indicates a period of time between words. Here, dₖ indicates a time interval between when a to word wₖ appears and when a word wₖ₋₁ appears. Accordingly, the probability of segmenting the document W=w₁, w₂, . . . , wₙ into m segments S=S₁, S₂, . . . , Sₘ may be determined by Equation 13 below.

$$Pr ( S \vert W , D ) = \frac{Pr ( W , D \vert S ) Pr ( S )}{Pr ( W , D )} \qquad ( 13 )$$

Since Pr(W,D) is a constant in a given range, the segmentation with the highest probability Ŝ is written as Equation 14.

$$\hat{S} = arg {max}_{S} Pr ( W \vert S ) Pr ( D \vert S ) Pr ( S ) \qquad ( 14 )$$

Since segments with different thematic topics have different distributions of words, and since words are statistically independent from each other within the range of one thematic topic, Pr(W|S) may be rewritten as Equation 15 when n, is a total number of words in a segment Sᵢ and wⱼⁱ is a j^{th} word in the segment Sᵢ.

$$Pr ( W \vert S ) = Pr ( {W}_{1} , {W}_{2} … {W}_{m} \vert S ) = {\prod }_{i = 1}^{m} {\prod }_{j = 1}^{{n}_{i}} Pr ( {w}_{j}^{i} \vert {S}_{i} ) \qquad ( 15 )$$

Here, Pr(wⱼⁱ|Sᵢ) may be determined according to Equation 16 below.

$$Pr ( {w}_{j}^{i} \vert {s}_{i} ) = {( \frac{{f}_{i} ( {w}_{j}^{i} ) + 1}{{n}_{i} + u} )}^{α} \qquad ( 16 )$$

where fᵢ(wⱼⁱ) is the number of wⱼⁱ included in Wᵢ, and “u” is the number of different words included in the entire document W.

However, in the case of captions, there may be a relatively long time delay between sentences. Accordingly, the probability that there is a point of segmentation is increased, such that Pr(D|S) may be determined by Equation 17 below.

$$Pr ( {d}_{j}^{i} \vert S ) = {( \frac{1}{{d}_{j}^{i}} )}^{β} \qquad ( 17 )$$

The final term Pr(S) may be a variable depending on prior information. To exclude presumptions of any prior information for S, Pr(S) is determined by Equation 18 below.

Pr(S)=(n^{-m})^{γ} (18)

In order to obtain a segmentation Ŝ, a cost of the segmentation Ŝ may be determined by

Equation 19 below.

C(S)=−log Pr(W|S)Pr(D|S)Pr(S) (19)

Equation 19 may be rewritten as the following Equation 20 by substituting Equations 16, 17, and 18 into Equation 19 and rearranging the terms.

$$\begin{matrix}C ( {S}_{i} ) = c ( {w}_{1}^{i} {w}_{2}^{i} … {w}_{{n}_{i}}^{i} \vert n , u ) \\ = α \cdot {\sum }_{j = 1}^{{n}_{i}} log \frac{{n}_{i} + u}{{f}_{i} ( {w}_{j}^{i} ) + 1} + β \cdot {\sum }_{i = 1}^{{n}_{i}} log ( {d}_{j}^{i} ) + γ \cdot log n ,\end{matrix} \qquad ( 20 )$$

where α+β+γ=1.

The text segmentation processor 720 segments received captions into two segments. A cost cⱼ may be calculated at the boundary location between words using Equation 21 below.

cⱼ=c(w₁w₂ . . . wⱼ|n, u)+c(wⱼ₊₁wⱼ₊₂. . . wₙ|n, u) (21)

where j=1, 2, . . . n−1.

A minimum of cⱼ may be referred to as cₘᵢₙ. Accordingly, a text segmentation cost TCost(t) at an arbitrary time t may be calculated by Equation 22 below.

$$T Cost ( t ) = \{ \begin{matrix}1 - {( \frac{{c}_{min}}{{c}_{j}} )}^{p} , & When t is within the interval of {d}_{j} \\ 1 , & otherwise\end{matrix} \qquad ( 22 )$$

The text segmentation processor 720 may segment captions based on the boundaries of sentences. Accordingly, the text segmentation processor 720 may calculate cⱼ only for a location corresponding to a boundary of sentences. In Equation 22, the case where TCost(t) is 1 corresponds to when no sentence boundary appears, that is, when t belongs to a region where a certain sentence is proceeding.

Referring again to FIG. 7, the linearly merged segmentation cost estimator 730 merges the scene segmentation cost NCutₖ(Aⱼ,Āᵢ) of video content with the estimated text segmentation cost TCost(t), providing a final merged segmentation cost, which may be written as Equation 23.

Cost(Seg at j|k)=α·NCutₖ(Aⱼ, Āᵢ)+β·TCost(Tⱼ), (23)

where α+β=1 and Tⱼ is a time at the location of a shot j. Here, weights α and β respectively are weights for the scene segmentation cost NCutₖ(Aⱼ,Āᵢ) and the estimated text segmentation cost TCost(t). Additionally, the weights α and β may be distinguished from weights used for estimating a text segmentation cost in Equation 20.

Whenever a shot is detected, the merged scene segmentation detector 740 may determine and record an optimal segmentation location jₘᵢₙ(k) at which a scene segmentation cost is minimized, according to Equation 24.

$${j}_{min} ( k ) = arg {min}_{j} Cost ( Seg at j \vert k ) \qquad ( 24 )$$

If a value of a location jₘᵢₙ(k) at which a merged segmentation cost is minimized is 1 as k increases, it can be considered that a segmentation is stable at the location of jₘᵢₙ(k). Accordingly, as described above with reference to Equation 12, a scene segmentation location may be determined.

Furthermore, another method for deciding a scene segmentation location is to determine a segmentation location jₘᵢₙ(k) at which a merged scene segmentation cost is minimized and which appears with the highest frequency within a given window T_{w}. This method is described above with reference to FIG. 6.

In the above descriptions with reference to FIG. 7, a method is proposed which detects a scene segmentation location according to a scene-text merged segmentation cost obtained using a scene segmentation cost estimated by the video segmentation processor 710 and a text segmentation cost estimated by the text segmentation processor 720. However, when no text segmentation cost can be estimated (such as when no text is received), as described above with reference to FIG. 3, the merged scene segmentation detector 740 may detect a scene segmentation location at which a minimum scene segmentation cost is repetitively and stably detected, using only a scene segmentation cost for video data. Similarly, when no scene segmentation cost for video data received over time can be estimated, the merged scene segmentation detector 740 may detect a scene segmentation location at which a minimum text segmentation cost is repetitively and stably detected, using only a text segmentation cost estimated by the text segmentation processor 720.

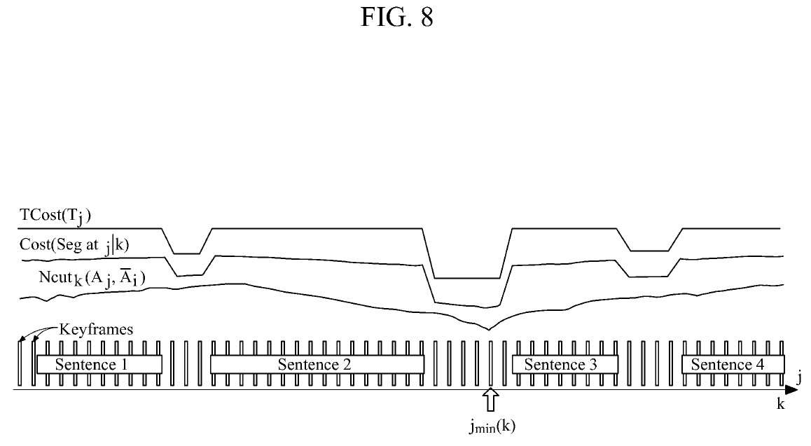

FIG. 8 is a diagram illustrating an example of a final cost obtained by linear merging of scene segmentation costs and text segmentation costs.

FIG. 8 illustrates a normalized-cut NCutₖ(Aⱼ,Āᵢ), a text segmentation cost TCost(Tⱼ), and a merged segmentation cost Cost(Seg at j|k) that are calculated whenever a shot or a caption is detected.

As illustrated in FIG. 8, whenever a shot or caption is received, jₘᵢₙ(k), at which a linearly merged cost Cost(Seg at j|k) of a scene segmentation cost NCutₖ(Aⱼ,Āᵢ) and a text segmentation cost TCost(Tⱼ) is minimized, may be detected as a merged scene segmentation detection location j_{seg}(k).

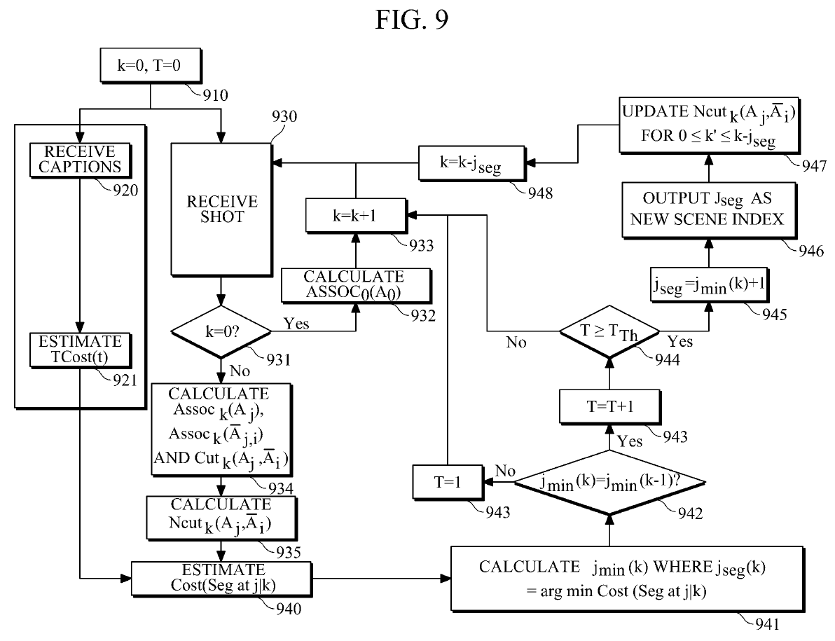

FIG. 9 is a flowchart illustrating examples of operations in which the scene segmentation apparatus 700 of FIG. 7 applies scene segmentation to video content received in substantially real-time.

The real-time scene segmentation method may start in a state of setting both an index k of a shot and the number of times T which the same segmentation location is detected to “0” (910).

Referring to FIGS. 7 and 9, the text segmentation processor 720 estimates, when receiving captions (920), a text segmentation cost TCost(t) according to the text segmentation method described above (921).

The video segmentation processor 710 determines, when receiving a shot detected by a shot detection algorithm, whether k is 0 (931). If k is 0, it is determined that a single shot is received. Accordingly, the video segmentation processor 710 calculates Assoc₀(A₀) (932). The video segmentation processor 710 increases k by 1 (933) and receives a next shot (930).

Since k is not 0 when two or more shots are received (931), the video segmentation processor 710 calculates Assocₖ(Aⱼ), Assocₖ(Ā_{j,i}) and Cutₖ(Aⱼ,Āᵢ) (934).

The video segmentation processor 710 calculates NCutₖ(Aⱼ,Āᵢ) using Assocₖ(Aⱼ), Assocₖ(Ā_{j,i}) and Cutₖ(Aⱼ,Āᵢ) (935).

The merged segmentation cost estimator 730 may estimate a merged segmentation cost Cost(Seg at j|k) by linear merging the text segmentation cost TCost(t) and the scene segmentation cost NCutₖ(Aⱼ,Āᵢ) (940).

The merged scene segmentation detector 740 calculates a location jₘᵢₙ(k) at which the merged segmentation cost Cost(Seg at j|k) is minimized (941).

Thereafter, the merged scene segmentation detector 740 determines whether the newly calculated location jₘᵢₙ(k), at which the merged scene segmentation cost Cost(Seg at j|k) is minimized, is identical to the previously calculated location jₘᵢₙ(k−1) at which a merged scene cost is minimized (942). The merged scene segmentation detector 740 sets, if jₘᵢₙ(k)≠jₘᵢₙ(k−1) (942), the number of scene segmentation T to “1” and increases k by 1 (933). The scene segmentation apparatus 700 returns to operation 930 and receives a next shot.

Meanwhile, if jₘᵢₙ(k)=jₘᵢₙ(k−1) (942), the merged scene segmentation detector 740 increases the number of scene segmentation T by 1 (943). The merged scene segmentation detector 740 increases k by 1 when the increased number of scene segmentation T does not reach a threshold number of scene segmentation T_{TH} (933). The scene segmentation apparatus 700 returns to operation 930 and receives a next shot. The operations 930 to 942 are repeated until the number of scene segmentations T reaches the threshold number of scene segmentations T_{TH}.

When the increased number of scene segmentation T reaches or exceeds the threshold number of scene segmentation T_{TH} (944), the merged scene segmentation detector 740 determines a location j_{seg} at which scenes are segmented as a scene segmentation location jₘᵢₙ(k)+1 (945).

The merged scene segmentation detector 740 outputs j_{seg} as a new scene index (946). Since scene segmentation for shots before j_{seg} being detected as a new scene index are no longer needed, the merged scene segmentation detector 740 outputs the scene index j_{seg} to the video segmentation processor 710 (946).

The video segmentation processor 710 updates NCutₖ(Aⱼ,Āᵢ) for shots following j_{seg} that are to be subject to scene segmentation (947). The video segmentation processor 710 sets k=k−j_{seg} (948) and continues to receive a newly detected shot (930). Accordingly, it is possible to, in real-time, detect scenes which are semantic segments for video content transmitted in real-time through broadcasting and/or communications.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD-ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A scene segmentation apparatus, comprising:
a scene segmentation cost estimator to receive shots and to estimate scene segmentation costs using an estimation value such that a similarity between shots included in each of two groups of shots is maximized and a similarity between the two groups of shots is minimized; and
a scene segmentation detector to detect a scene segmentation location between the shots, with reference to the scene segmentation costs,
wherein the scene segmentation location is a location at which the scene segmentation cost is minimized.

2. The scene segmentation apparatus of claim 1, further comprising:
a memory to store the results of calculations for detecting the scene segmentation location for the received shots,
wherein the scene segmentation cost estimator recursively estimates, when a new shot is received, scene segmentation costs for shots including the newly received shot and any of previously received shots, using the stored results of the calculations.

3. The scene segmentation apparatus of claim 1, wherein, when detecting the scene segmentation location, the scene segmentation cost estimator distributively estimates scene segmentation costs for shots remaining after the scene segmentation location, while continuing to receive new shots.

4. The scene segmentation apparatus of claim 1, wherein, when a first location at which the scene segmentation cost is minimized is repetitively detected at least a predetermined number of times, the scene segmentation detector determines the first location as the scene segmentation location.

5. The scene segmentation apparatus of claim 1, wherein the scene segmentation detector determines the scene segmentation location according to a location with highest frequency of minimizing scene segmentation costs within a window that is determined as a predetermined number of shots or as a predetermined time period.

6. The scene segmentation apparatus of claim 1, further comprising:
a text segmentation processor to estimate a text segmentation cost for text received over time;
a merged segmentation cost estimator to estimate a scene-text merged segmentation cost by linear merging of the estimated text segmentation cost and the estimated scene segmentation cost; and
a merged scene segmentation detector to detect a scene segmentation location at which the merged segmentation cost is minimized.

7. The scene segmentation apparatus of claim 6, wherein the text segmentation processor segments text into text segments by applying time intervals between words to a statistical model for text segmentation.

8. The scene segmentation apparatus of claim 6, wherein the scene segmentation detector determines a second location as the scene segmentation location when the second location at which the merged segmentation cost is minimized is repeatedly detected at least a predetermined number of times.

9. The scene segmentation apparatus of claim 6, wherein the scene segmentation detector determines the scene segmentation location according to a location with highest frequency of minimizing merged segmentation costs within a window that is determined as a predetermined number of shots or as a predetermined time period.

10. A scene segmentation method, comprising:
estimating, when a new shot is received, scene segmentation costs using an estimation value such that a similarity between shots included in each of two groups of shots is maximized and a similarity between the two groups of shots is minimized; and
detecting a scene segmentation location between the shots, with reference to the scene segmentation costs,
wherein the scene segmentation location is a location at which the scene segmentation cost is minimized.

11. The scene segmentation method of claim 10, further comprising:
storing the result of detecting the scene segmentation location for the received shots; and
recursively estimating, when a new shot is received, scene segmentation costs for shots including the newly received shot and any of previously received shots, using the stored results of the calculations.

12. The scene segmentation method of claim 10, further comprising, distributively estimating scene segmentation costs for shots remaining after the scene segmentation location, while continuing to receive new shots.

13. The scene segmentation method of claim 10, further comprising:
estimating a text segmentation cost for text received over time;
estimating a scene-text merged segmentation cost by linear merging of the estimated text segmentation cost and the estimated scene segmentation cost; and
detecting a scene segmentation location at which the scene-text merged segmentation cost is minimized.

14. The scene segmentation method of claim 13, wherein the calculating of the text segmentation cost is performed using a text segmentation model in which time intervals between words are applied to a statistical model for text segmentation.

15. The scene segmentation method of claim 13, wherein the detecting of the scene segmentation location comprises determining a first location as the scene segmentation location when the first location at which the merged scene segmentation cost is minimized is repetitively detected at least a predetermined number of times.

16. The scene segmentation method of claim 13, wherein the detecting of the scene segmentation location comprises determining the scene segmentation location according to a location with highest frequency of minimizing merged scene segmentation costs within a window that is determined as a predetermined number of shots or as a predetermined time period.

17. A scene segmentation apparatus. comprising:
a text segmentation processor to estimate a text segmentation for text received over time; and
a scene segmentation detector to detect a scene segmentation location of video data received over time according to the text segmentation cost.

18. The scene segmentation apparatus of claim 17, wherein the text segmentation processor segments text into text segments by applying detected time intervals between words to a statistical model for text segmentation.

19. The scene segmentation apparatus of claim 17, wherein the scene segmentation detector determines the scene segmentation location according to a text segmentation location at which the text segmentation cost is repetitively detected at least predetermined number of times for the received shots.

20. The scene segmentation apparatus of claim 17, wherein the scene segmentation detector determines the scene segmentation location according to a location with highest frequency of minimizing text segmentation costs within a window that is determined as a predetermined number of shots or as a predetermined time period.
